(19) United States
(12) Patent Application Publication
(10) Pub. No.: US 2017/0068449 A1
(43) Pub. Date: Mar. 9, 2017

(54) METHOD, COMPUTER PROGRAM AND DEVICE FOR PROVIDING COGNITIVE SUPPORT OF A USER INTERFACE

(71) Applicant: Norsk Telemedisin AS, Egersund (NO)

(72) Inventors: Arild STAPNES JOHNSEN, Egersund (NO); Gunnar CRAWFORD, Stavanger (NO); Dagfinn WÅGE, Stavanger (NO); Theresa HARMANEN, N-Stavanger (NO); Harald SÆVAREID, Stavanger (NO)

(21) Appl. No.: 15/123,540

(22) PCT Filed: Mar. 6, 2015
(86) PCT No.: PCT/EP2015/054752

§ 371 Date: Sep. 2, 2016

(30) Foreign Application Priority Data
Mar. 6, 2014 (NO) 20140304

(51) Int. Cl. G06F 3/0489; G06F 3/0481; H04N 21/4788; H04N 7/15; H04N 21/422; H04L 29/06; G06F 3/023

(52) U.S. Cl. CPC G06F 3/04895; H04L 65/403; G06F 3/04817; H04L 65/4076; G06F 3/023; H04N 7/15; H04N 21/42218; H04N 21/42207; H04N 21/4221; H04N 21/4788

(57) ABSTRACT

A video conferencing endpoint (terminal) is equipped with one or more screens, one or more loudspeakers, a microphone and a codec. The user usually interacts with the endpoint by a remote control 100 or a user panel and a GUI 110 displayed on the screen for controlling the endpoint. The most basic commands are related to making a call and receiving a call. The communication is one-way communication from the remote control the endpoint, that may be provided by Infrared signals. However, according to embodiments herein, a feedback channel from the endpoint back to the remote control is provided. In addition, the different buttons 101-106 on the remote control are provided with illumination means of different colors corresponding to colors highlighting icons in the GUI 110 representing user actions which are being activated when pushing the respective buttons.

### TECHNICAL FIELD

The present invention relates to methods and computer implemented applications for providing cognitive support in a user interaction between a remote control and a Graphical User Interface (GUI) displayed on a screen included in an endpoint or a user terminal.

### BACKGROUND

Transmission of moving pictures in real-time is employed in several applications like e.g. video conferencing, net meetings and video telephony.

Video conferencing systems allow for simultaneous exchange of audio, video and data information among multiple conferencing sites. A video conference terminal basically consists of a camera, a screen, a loudspeaker, a microphone and a codec. These elements may be assembled in a stand-alone device for video conference purposes only (often referred to as an endpoint) or it may be embedded in multi-purpose devices like personal computers and Televisions.

Video conference terminals are usually controlled by a remote control interacting with a Graphical User Interface displayed on the screen. The main problem of current video control systems is the high user threshold related to the interaction between the remote control and the GUI, and an uncertainty of the selection to make by a user in different situations and events. Hence, there is a need for providing an assistive and situational system which is comprehensive and intuitive for all users independently of technical skills.

### SUMMARY

An objective of embodiments herein is to overcome or at least alleviate the above mentioned disadvantage. This object and other objects are achieved by providing a method for providing cognitive support in a user interaction between a remote control and a Graphical User Interface (GUI) displayed on a screen included in an endpoint or a user terminal, wherein a number of icons in the GUI representing a number of user actions are provided. The user interaction provides two-way communication between the remote control and the endpoint, and, by means for illuminating, illumination of a number of buttons on the remote control with a number of colors, and, by the means for illumination, illumination of a first button of the number of buttons with a first color corresponding to a color highlighting a first icon of the number of icons in the GUI representing a first action of the number of user actions which is being activated when pushing the first button.

In other embodiments, the two-way communication between the remote control and the endpoint may include a feedback channel from the endpoint or terminal to the remote which is Bluetooth compliant.

In other embodiments, the number of user actions may include setting up a call, receiving a call, selecting a contact list or selecting a general feature provided by the endpoint or terminal.

In other embodiments, the number of user actions may include extinguishing the illumination means of the first button illuminated with the first color, and illuminating a second button of the number of buttons with the first color positioned on the left hand side, on the right hand side, below or above the first button.

In other embodiments, the GUI may be overlaid on a currently displayed TV image or a video conference on the screen.

According to another aspect, the above mentioned object and other objects are achieved by providing an arrangement for providing cognitive support in a user interaction between a remote control and a Graphical User Interface (GUI) displayed on a screen included in an endpoint or a user terminal. A number of icons in the GUI are representing a number of user actions. The arrangement comprises at least one communication device providing two-way communication between the remote control and the endpoint, at least one illumination device providing illuminating of a number of buttons on the remote control with a number of colors. The at least one illumination device provides illumination of a first button of the number of buttons with a first color corresponding to a color highlighting a first icon of the number of icons in the GUI representing a first action of the number of user actions which is being activated when pushing the first button.

In other embodiments, the two-way communication between the remote control and the endpoint may include a feedback channel from the endpoint or terminal to the remote which is Bluetooth compliant.

In other embodiments, the number of user actions may include setting up a call, receiving a call, selecting a contact list or selecting a general feature provided by the endpoint or terminal.

In other embodiments, the number of user actions may include extinguishing the illumination means of the first button illuminated with the first color, and illuminating a second button of the number of buttons with the first color positioned on the left hand side, on the right hand side, below or above the first button.

In other embodiments, the GUI may be overlaid on a currently displayed TV image or a video conference on the screen.

According to still another aspect, the above mentioned object and other objects are achieved by providing a computer program, comprising computer readable code units which when executed on an electronic device causes the electronic device to perform any of the methods described herein.

According to still another aspect, the above mentioned object and other objects are achieved by providing a carrier comprising the computer program according to the preceding claim, wherein the carrier is one of an electronic signal, an optical signal, a radio signal and a computer readable medium.

According to still another aspect, the above mentioned object and other objects are achieved by providing a computer program product providing cognitive support in a user interaction between a remote control and a Graphical User Interface (GUI) displayed on a screen included in an endpoint or a user terminal. A number of icons in the GUI representing a number of user actions are provided. The computer program product comprises a computer-readable storage medium having computer-readable program code embodied in said medium. The computer-readable program code comprises computer readable program code configured to execute all the steps of any of the methods described herein.

### BRIEF DESCRIPTION OF THE DRAWINGS

FIG. 1 is a first snapshot of a relation between a remote control and a user interface in a first example event,

FIG. 2 is a first snapshot of a relation between a remote control and a user interface in a second example event,

FIG. 3 is a third snapshot of a relation between a remote control and a user interface in a third example event,

FIG. 4 is a fourth snapshot of a relation between a remote control and a user interface in a fourth example event

### DETAILED DESCRIPTION OF EXAMPLE EMBODIMENTS

Embodiments herein describe methods providing cognitive support in the interaction between a remote control and a Graphical User Interface (GUI) with a universal design, especially for use in video conferencing.

A video conferencing endpoint (e.g. a terminal) is equipped with one or more screens, one or more loudspeakers, a microphone and a codec. The user usually interacts with the endpoint by a remote control or a user panel (from now on referred to as a remote control) and a GUI displayed on the screen for controlling the endpoint. The most basic commands are related to making a call and receiving a call. The communication is a one-way communication from the remote control to the endpoint, that may be provided by Infrared signals.

However, according to embodiments herein, a feedback channel from the endpoint back to the remote control is provided. In addition, the different buttons on the remote control are provided with illumination means of different colors corresponding to colors highlighting icons in the GUI representing user actions which are being activated when pushing the respective buttons.

Differently from a conventional remote control using IR communication, the remote control herein may be a Bluetooth Smart compliant. Bluetooth Smart defines a large collection of services, including e.g. keyboards (e.g. Human Interface Devices (HID devices)) and heart rate monitors. Embodiments herein define a profile, which includes the applicable services and possibly a custom-defined service for Light Emitting Diodes (LEDs) providing the illumination of the buttons.

Bluetooth Smart optionally also supports encryption using an 128-bit Advanced Encryption Standard (AES) cypher.

For practical implementation of Bluetooth in the remote control for the purpose herein, a chip of low power consumption, being able to live off the AAA battery in the remote for months should be used.

The feedback channel may then be used to transmit information about events and changes in states occurring in the endpoint requiring or inviting for a user action. The event may either be initiated from the user through the remote control, or as a result of an external request like an incoming call to the endpoint. The information transmitted through the feedback channel may be an indication of how the buttons on the remote control should be illuminated so as to provide a logical relation between the button illumination and the current GUI event indication which is displayed on the screen. A protocol defining representations of different states should be provided to be communicated through the feedback channel. According to one embodiment, the use of the feedback channel is minimized by providing a state machine in the remote control and the endpoint, respectively, so that transitions between states would be synchronized on each side depending on the occurring actions (e.g. selection of the user or external events). However, in the embodiments discussed in the following, it is assumed that instructions of change in the button illumination state of the remote control are explicitly communicated through the feedback channel according to the abovementioned protocol.

Any illumination of the buttons of the remote control will indicate an invitation or a request for a user action. The specific button illumination will also indicate which of the buttons that will activate an action in the specific event, and therefore support the user in navigating in the GUI, and in addition to assisting the user of making a correct choice and removing unnecessary doubt.

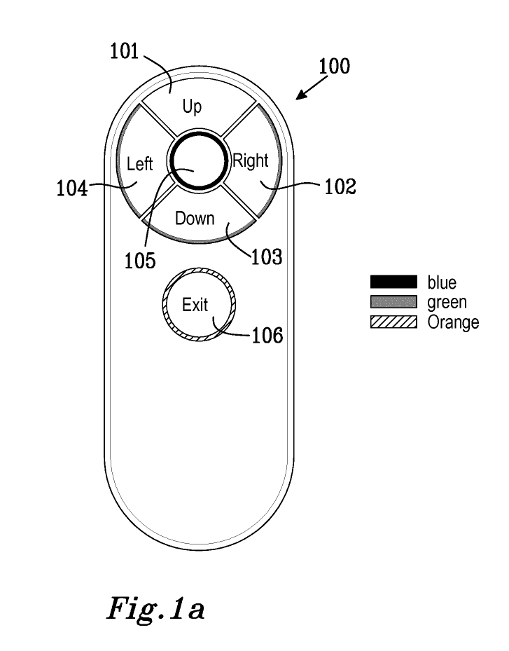

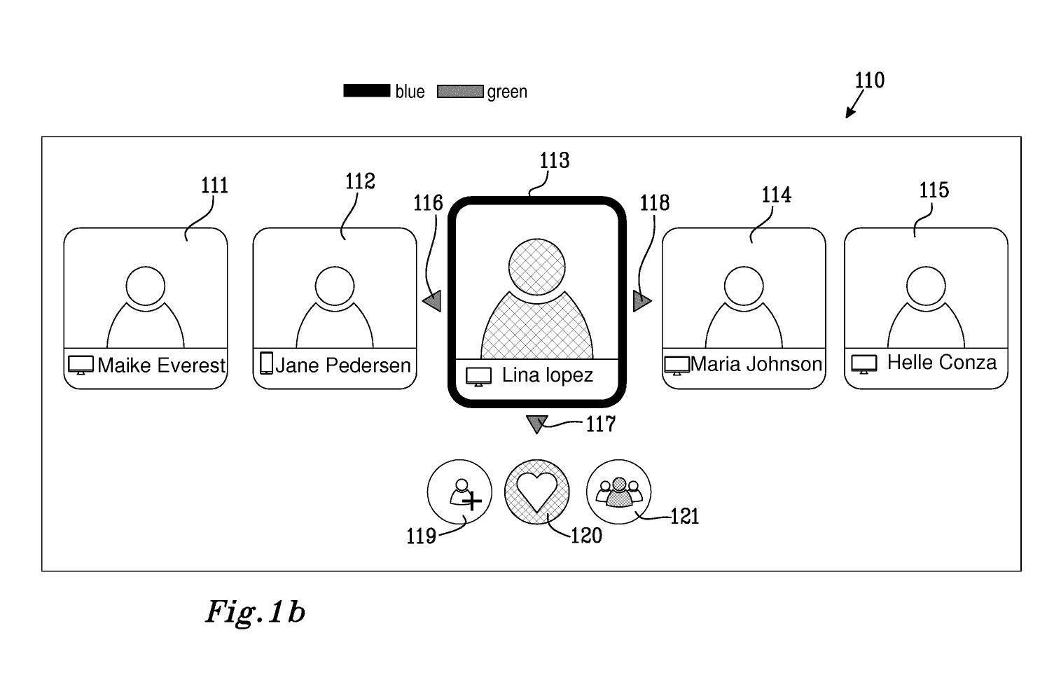

FIG. 1 shows a first snapshot of a relation between a remote control 100 and a user interface 110 in a first example event according to one embodiment. FIG. 1a illustrates an example design of the remote control 100 with some of the buttons 101-106 illuminated, e.g. buttons 102-106, and FIG. 1b illustrates an example of a corresponding appearance of the GUI 110. Prior to this event, the user has transmitted a command for making a call from the remote control 100. A row of different contacts that are possible to call is therefore displayed in the GUI 110 represented by icons 111-115 including names and portraits. One of the contacts 113 is provided with a blue colored frame, and the centered button 105 of the remote control 100 is illuminated with a corresponding blue light. This indicates that when pushing the blue illuminated button 105, a signal is transmitted from the remote control 100 to the endpoint instructing a call to be established from the endpoint to the video contact 113 framed by the blue line in the GUI 110.

Still referring to FIG. 1, three buttons 102,103,104 on the remote control 100 are illuminated with a green light, respectively positioned on the left hand side, below and on the right hand side of the centered button 105, while there are three green colored arrows 116,117,118 respectively positioned on the left hand side, below and on the right hand side of the blue colored framed contact icon 113. The bottom button 106 is illuminated with an orange colored frame. By pushing the left hand side or the right hand side illuminated buttons 104,102, a signal is transmitted from the remote control 100 to the endpoint instructing to shift the position of the blue colored frame from the contact 113 to the left or to the right in the contact row 111-115.

By pushing the green illuminated the button 103 below the centered button 105, a signal is transmitted from the remote control 100 to the endpoint instructing to shift the position of the blue colored border from the contact 113 down to a row of icons 119,120,121 representing possible activation of other functions.

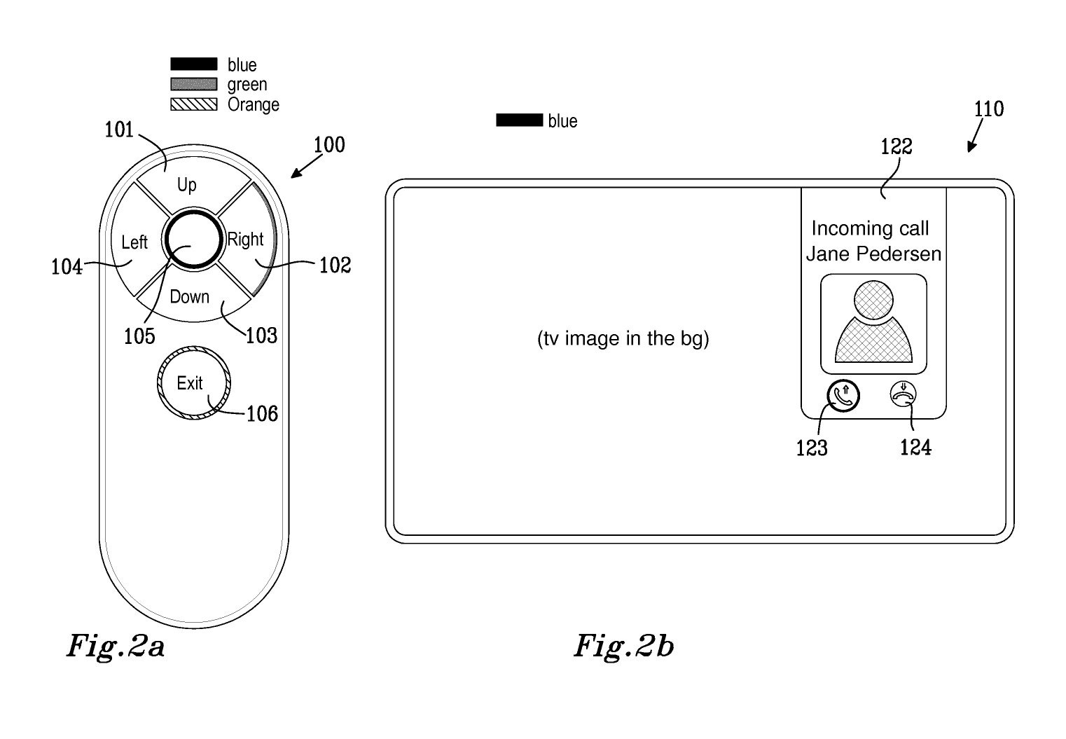

FIG. 2 shows a second snapshot of a relation between a remote control 100 and a user interface 110 in a second example event according to one embodiment. FIG. 2a illustrates an example design of a remote control 100 with some of the buttons 101-106 illuminated, e.g. buttons 102,105,106, and FIG. 2b illustrates an example of a corresponding appearance of the GUI 110. Prior to this event, the endpoint has received an incoming call. The incoming call is indicated by a dropdown window 122 overlaid on e.g. a currently displayed TV image on the screen. The dropdown window 122 includes a name and a portrait corresponding to the user of the incoming call, in addition to two icons 123,124 representing “accept call” and “reject call”, respectively.

The incoming call also initiates transmission of a signal on the feedback channel to the remote control 100 indicating that an incoming call is present. This indication then sets a predefined illumination combination of the buttons 101-106 on the remote control 100. In the example of FIG. 2a, the centered button 105 of the remote control 100 is illuminated with blue color frame, the right hand side 102 of the centered button 105 is illuminated green color frame, and the bottom button 106 is illuminated with orange colored frame.

Still referring to FIG. 2, by pushing the blue colored center button 105, a signal is transmitted from the remote control 100 to the endpoint instructing the endpoint to accept the incoming call. By pushing the green colored button 102, a signal is transmitted from the remote control 100 to the endpoint instructing to shift the position of the blue colored frame 123 to the reject call icon 124. A new state has then occurred (not shown), implying that pushing the blue colored center button 105, a signal is transmitted from the remote control 100 to the endpoint instructing the endpoint to reject the incoming call.

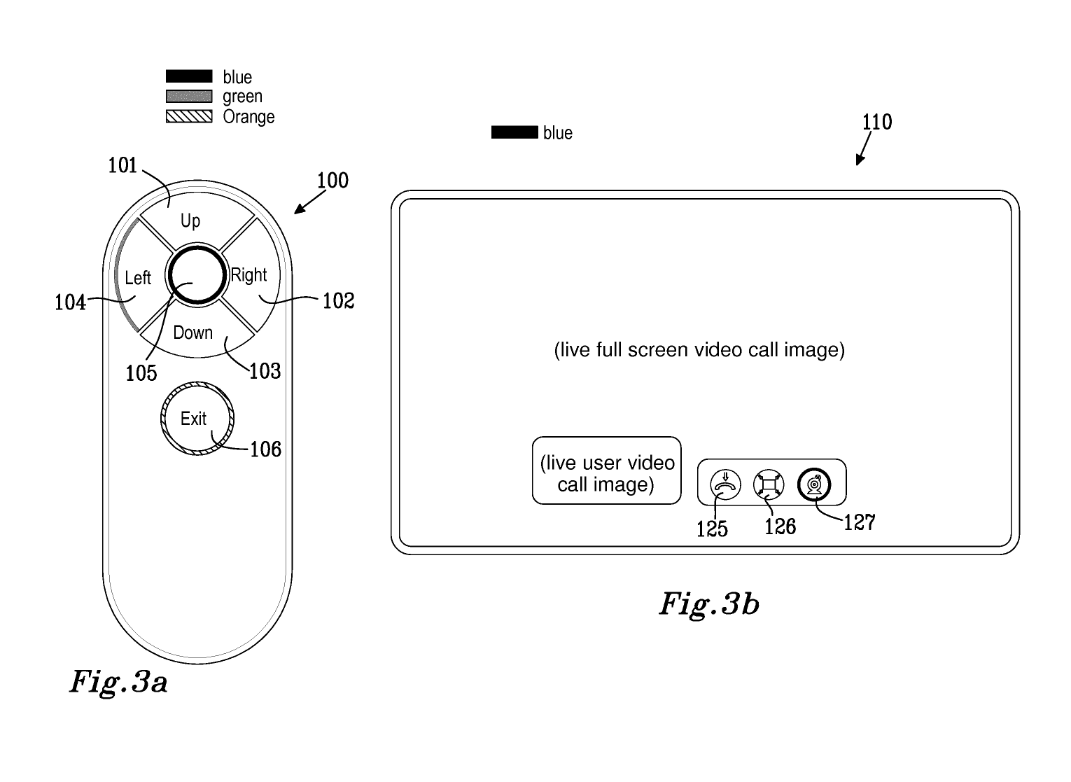

FIG. 3 shows a third snapshot of a relation between a remote control 100 and a user interface 110 in a third example event according to one embodiment. FIG. 3a illustrates an example design of a remote control 100 with some of the buttons 101-106 illuminated, e.g. buttons 104,105,106, and FIG. 3b illustrates an example of a corresponding appearance of the GUI 110. Prior to this event, the user has transmitted a command for changing the display content during a video call. A small row of three different selections is therefore displayed in the GUI 110 represented by icons 125,126,127 indicating the selectable alternatives. The small row is here placed overplayed on a large live video image and next to a small live user image.

In the example of FIG. 3b, the rightmost icon 127 of the small row in the GUI 110 is provided with a blue frame, indicating that a signal is transmitted from the remote control 100 to the endpoint instructing the endpoint to close camera with a curtain when pushing the blue framed center button 105 of the remote control 100. Since the only possibility for moving the blue icon frame of the rightmost icon 127 is towards the left, only the left hand side button 104 of the centered button 105 on the remote control 100 is illuminated with a green colored frame. Also in this exemplifying embodiment, the bottom button 106, i.e. the exit button, is illuminated with an orange colored frame.

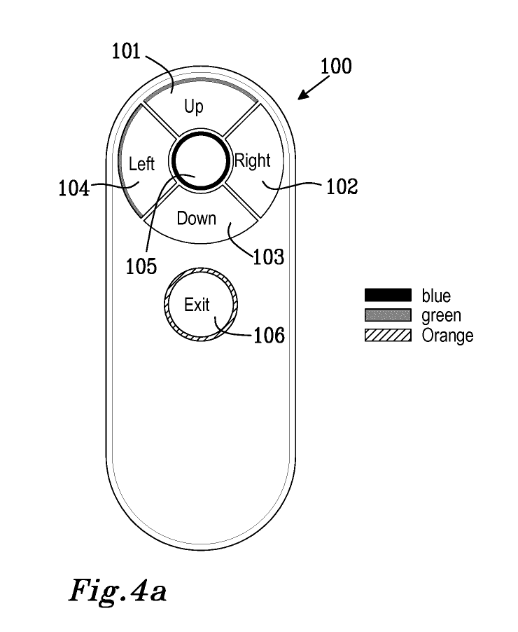

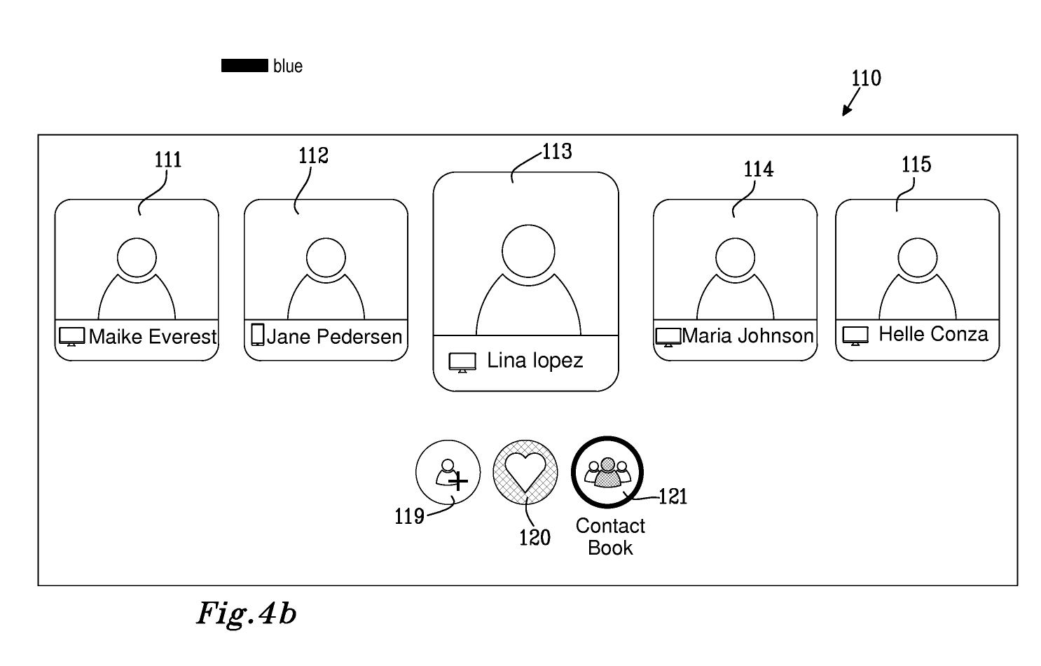

FIG. 4 shows a fourth snapshot of a relation between a remote control 100 and a user interface 110 in a fourth example event according to one embodiment. FIG. 4a illustrates an example design of a remote control 100 with some of the buttons 101-106 illuminated, e.g. buttons 101,104,105,106, and FIG. 4b illustrates an example of a corresponding appearance of the GUI 110. Prior to this event, the user has selected to see his/her contact list. A row of different contacts that are possible to call is therefore displayed in the GUI 110 represented by icons 111-115 including names and portraits. Below this row there are three icons 119,120,121, each representing a certain function. The contact list icon 121 is in the rightmost position of this row, and is illuminated with blue light, since the user has just selected the contact list option. In this position, the blue icon frame can possibly be moved from the contact list icon 121 up to the contact list row, or to the left along the function row. Thus, button 101 above and the left hand side button 104 of the centered button 105 on the remote control 100 are both illuminated with a green colored frame. Also in this exemplifying embodiment, the bottom button 106 is illuminated with an orange colored frame. By pushing the green illuminated button 101 above the centered button 105, a signal is transmitted from the remote control 100 to the endpoint instructing to shift the position of the blue colored frame up to the middle icon 113 of the contact row, ending up in the first example event as described above. By pushing the green illuminated left hand side button 104 of the centered button 105, a signal is transmitted from the remote control 100 to the endpoint instructing to shift the position of the blue colored frame to the middle icon 120 of the function icon row. At the same time, the feedback channel transmits information back to the remote control 100 about the new state, implying to turn on the illumination of the right hand side button 102 of the centered button 105 and to turn off the illumination on the above button 101.

A new state has then occurred (not shown), implying that pushing the blue colored center button 105, a signal is transmitted from the remote control 100 to the endpoint instructing the endpoint to activate the function represented by the heart shaped icon 120.

It should be understood that in the exemplifying embodiments described above, the colors blue, green and/or orange are only mentioned as examples and that other colors may be used. Further, instead of specifying the colors, reference may be made to a first color, a second color and/or a third color, etc.

In some embodiments, an illumination of a button of the remote control 100 with the first color may indicate that an icon of the user interface 110, which icon also is illuminated with the first color may be selected by means of the illuminated button on the remote control 100. Thus, the first color may indicate a selecting button and a selectable icon. Confer for example FIGS. 1a and 1b wherein the contact icon 113 is a selectable icon which may be selected by means of the illuminated centered button 105 of the remote control 100.

Further, in some embodiments, an illumination of a button and/or icon with the second color may indicate a possibility to change selectable icon in a direction indicated by the button and/or icon illuminated with the second color. Referring again to FIGS. 1a and 1b, wherein the right button 102, the down button 103, and the left button 104 on the remote control 100 are illuminated with the second color indicating that the selectable icon on the user interface 100 may be changed from the contact icon 113 to the contact icon 114, the icon 120 and the contact icon 112 by pressing the right button 102, the down button 103, and the left button 104, respectively. In the exemplifying embodiment of FIG. 1b, this is also illustrated in the user interface 110 by the arrows 118,117 and 116, respectively, illuminated with the second color.

The above description is merely illustrative examples of different embodiments of the present invention, and is not limiting the scope of the invention as defined in the following independent claims and the corresponding summary of the invention as disclosed above.

1. A method for providing cognitive support in a user interaction between a remote control and a Graphical User Interface, GUI, displayed on a screen included in one of an endpoint and a user terminal, a number of icons in the GUI representing a number of user actions are provided, the method comprising:
providing two-way communication between the remote control and the endpoint, the two-way communication including a feedback channel,
providing, by means for illuminating, illumination of a number of buttons on the remote control with a number of colors;
providing, by the means for illumination, illumination of a first button of the number of buttons with a first color corresponding to a color highlighting a first icon of the number of icons in the GUI representing a first action of the number of user actions which is being activated when pushing the first button; and
providing, based on information communicated through the feedback channel, instructions of change in the button illumination state of the remote control.

2. The method of claim 1, wherein the two-way communication between the remote control and the endpoint includes a feedback channel from one of the endpoint and terminal, to the remote control which is Bluetooth compliant.

3. The method of claim 2, wherein the number of user actions includes one of setting up a call, receiving a call, selecting a contact list and selecting a general feature provided by the endpoint or terminal.

4. The method of claim 2, wherein the number of user actions includes extinguishing the illumination means of the first button illuminated with the first color, and illuminating a second button of the number of buttons with a second color positioned one of on a left hand side, on a right hand side, below the first button and above the first button.

5. The method of claim 4, wherein the GUI is overlaid on a currently displayed one of TV image and a video conference on the screen.

6. An arrangement for providing cognitive support in a user interaction between a remote control and a Graphical User Interface, GUI, displayed on a screen included in one of an endpoint and a user terminal, a number of icons in the GUI representing a number of user actions are provided, the arrangement comprising:
at least one communication device providing two-way communication between the remote control and the endpoint, the two-way communication including a feedback channel;
at least one illumination device providing illuminating of a number of buttons on the remote control with a number of colors;
wherein the at least one illumination device providing:
illumination of a first button of the number of buttons with a first color corresponding to a color highlighting a first icon of the number of icons in the GUI representing a first action of the number of user actions which is being activated when pushing the first button; and
based on information communicated through the feedback channel, instructions of change in the button illumination state of the remote control.

7. The arrangement of claim 6, wherein the two-way communication between the remote control and the endpoint includes a feedback channel from the one of endpoint and terminal, to the remote control which is Bluetooth compliant.

8. The arrangement of claim 7, wherein the number of user actions includes one of setting up a call, receiving a call, selecting a contact list and selecting a general feature provided by one of the endpoint and terminal.

9. The arrangement of claim 8, wherein the number of user actions further includes extinguishing the illumination means of the first button illuminated with the first color, and illuminating with a second color a second button of the number of buttons positioned one of on a left hand side, on a right hand side, below the first button and above the first button.

10. The arrangement of claim 8, further comprising that the GUI is overlaid on a currently displayed one of TV image and a video conference on the screen.

11. (canceled)

12. (canceled)

13. A computer program product providing cognitive support in a user interaction between a remote control and a Graphical User Interface, GUI, displayed on a screen included in one of an endpoint and a user terminal, a number of icons in the GUI representing a number of user actions are provided, the computer program product comprising a computer-readable storage medium having computer-readable program code embodied in said medium, said computer-readable program code comprising computer readable program code, which when executed by an electronic device, configures the electronic device to:
provide two-way communication between the remote control and the endpoint, the two-way communication including a feedback channel;
provide, by means for illuminating, illumination of a number of buttons on the remote control with a number of colors;
provide, by the means for illumination, illumination of a first button of the number of buttons with a first color corresponding to a color highlighting a first icon of the number of icons in the GUI representing a first action of the number of user actions which is being activated when pushing the first button;
provide, based on information communicated through the feedback channel, instructions of change in the button illumination state of the remote control; and
the two-way communication between the remote control and the endpoint including a feedback channel from one of the endpoint and terminal, to the remote control which is Bluetooth compliant.

14. The computer program product of claim 13, wherein the two-way communication between the remote control and the endpoint includes a feedback channel from one of the endpoint and terminal, to the remote control which is Bluetooth compliant.

15. The method of claim 14, wherein the number of user actions includes one of setting up a call, receiving a call, selecting a contact list and selecting a general feature provided by the endpoint or terminal.

16. The method of claim 15, wherein that the number of user actions further includes extinguishing the illumination means of the first button illuminated with the first color, and illuminating a second button of the number of buttons with a second color positioned one of on a left hand side, on a right hand side, below the first button and above the first button.

17. The method of claim 2, wherein the GUI is overlaid on a currently displayed one of TV image and a video conference, on the screen.

18. The method of claim 3, wherein the GUI is overlaid on a currently displayed one of TV image and a video conference, on the screen

19. The arrangement of claim 7, wherein the number of user actions includes extinguishing the illumination means of the first button illuminated with the first color, and illuminating with a second color a second button of the number of buttons positioned one of on a left hand side, on a right hand side, below the first button and above the first button.

20. The arrangement of claim 7, wherein the GUI is overlaid on a currently displayed one of TV image and a video conference, on the screen.

21. The arrangement of claim 9, wherein the GUI is overlaid on a currently displayed one of TV image and a video conference, on the screen.
